(19) United States
(12) Patent Application Publication
(10) Pub. No.: US 2018/0092117 A1
(43) Pub. Date: Mar. 29, 2018

(54) TRIGGERING SCHEME FOR WAKING UP AND SCHEDULING UPLINK TRANSMISSION OF IOT DEVICES

(71) Applicant: INTEL CORPORATION, SANTA CLARA, CA (US)

(72) Inventors: Shahrnaz AZIZI, Cupertino, CA (US); Eldad PERAHIA, Portland, OR (US); Thomas J. KENNEY, Portland, OR (US)

(21) Appl. No.: 15/277,472

(22) Filed: Sep. 27, 2016

(51) Int. Cl. H04W 72/12; H04W 76/04; H04L 5/00

(52) U.S. Cl. CPC H04W 72/1268; H04L 5/0055; H04W 72/1273; H04W 76/046

(57) ABSTRACT

A new staggered trigger scheme is described herein to address and optimize deployments using a mix of narrowband (NB) data packets with existing Wi-Fi devices. The approach has the access point (AP) sending staggered wideband trigger frames prepended with a legacy preamble. This signalling method allows frequency multiplexing of low-power NB (LP-NB) devices, in addition to time and frequency multiplexing of both LP-NB and wideband devices in both the downlink (DL) and uplink (UL) direction. Furthermore, the scheme allows for the multiplexing of the new wake-up packets with future narrowband and IEEE 802.11ax data packets. Thus, with this unique staggered trigger frame proposal, LP-NB and wake-up devices unable to transmit or decode the legacy 20 MHz preamble, can share the spectrum with legacy devices with full coexistence provided.

### TECHNICAL FIELD

An exemplary aspect is directed toward communications systems. More specifically an exemplary aspect is directed toward wireless communications systems and even more specifically to IEEE (Institute of Electrical and Electronics Engineers) IEEE 802.11 wireless communications systems. Even more specifically, exemplary aspects are at least directed toward one or more of IEEE (Institute of Electrical and Electronics Engineers) IEEE 802.11n/ac/ax/ . . . communications systems and in general any wireless communications system or protocol, such as 4G, 4G LTE, 5G and later, and the like.

### BACKGROUND

Wireless networks transmit and receive information utilizing varying techniques and protocols. For example, but not by way of limitation, two common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax standard.

The IEEE 802.11 standards specify a common Physical (PHY) Layer and Medium Access Control (MAC) Layer which provides a variety of functions that support the operation of IEEE 802.11-based Wireless LANs (WLANs) and devices. The PHY and MAC Layers manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the IEEE 802.11ax Task Group (TGax) within the IEEE 802.11 working groups is considering improvements to spectrum efficiency to enhance system throughput/area in high density scenarios of APs (Access Points) and/or STAs (Stations).

A rising concern for Wi-Fi networks for is the incorporation of Internet-of-Things (IoT) devices and/or applications. IoT devices are small, sometimes, battery operated sensors and devices that enhance the features of smart homes, smart building management, industrial automation, etc. For example, a Wi-Fi transceiver can be built into a temperature sensor in a HVAC duct, which cannot be reached easily, and hence requires on the order of five years of battery life. Besides battery life, the sensors and other IoT devices have to be low cost. One approach to reduce cost and power consumption, from current Wi-Fi devices, is to create a new narrow bandwidth operational mode. The recent IEEE 802.11ax amendment defines an OFDMA multiplexing technique with sub-channels as small as 2 MHz. However, the narrow bandwidth (NB) operation for IoT is different from IEEE 802.11ax, because the objective is to enable low power (LP) devices that operate with a bandwidth smaller than 20 MHz, for example approximately to 2 MHz to 2.6 MHz.

For IEEE 802.11ax OFDMA modes, even when a device transmits a 2 MHz signal, the device is required to first transmit the legacy preamble at 20 MHz. Transmission of the legacy preamble provides coexistence with legacy devices. This preamble transmission drastically limits the power savings that can be achieved. Thus, mechanisms to allow future LP devices to coexist with legacy devices is required.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an embodiment of an environment associated with the embodiments presented herein;

FIG. 2 illustrates an embodiment of a narrowband (NB) data uplink for lower-power narrowband stations (LP-NB STAs) using a stagger trigger;

FIG. 3 illustrates an embodiment of NB wake-up signalling for LP-NB STAs;

FIG. 4 illustrates an embodiment of a NB data downlink LP-NB STAs using a stagger trigger;

FIG. 5 illustrates an exemplary packet structure;

FIG. 6 is a flowchart outlining an exemplary technique for conducting data uplink at an AP in an environment including narrowband devices;

FIG. 7 is a flowchart outlining an exemplary technique for conducting data uplink at an assisting STA (AS) in an environment including narrowband devices;

FIG. 8 is a flowchart outlining an exemplary technique for conducting data uplink at a LP-NB STA in the wireless environment;

FIG. 9 is a flowchart outlining an exemplary technique for conducting a wake-up at an AP in an environment including narrowband devices;

FIG. 10 is a flowchart outlining an exemplary technique for conducting a wake-up at an assisting STA (AS) in an environment including narrowband devices;

FIG. 11 is a flowchart outlining an exemplary technique for conducting a wake-up at a LP-NB STA in the wireless environment;

FIG. 12 is a flowchart outlining an exemplary technique for conducting data downlink at an AP in an environment including narrowband devices;

FIG. 13 is a flowchart outlining an exemplary technique for conducting data downlink at an assisting STA (AS) in an environment including narrowband devices;

FIG. 14 is a flowchart outlining an exemplary technique for conducting data downlink at a LP-NB STA in the wireless environment;

FIG. 15 is an illustration of the hardware/software associated with a AS, LP-NB STA, and/or AP.

### DESCRIPTION OF EMBODIMENTS

The success of Wi-Fi being used for IoT/sensor applications lies on providing advantages over existing technologies such as Bluetooth™ and Zigbee™. Among promising advantages of Wi-Fi is the possibility of providing interference mitigation and coexistence methods with legacy IEEE 802.11a/g/b/n/ac/ax devices and deployment. A traditional approach to the coexistence problem has been defining a packet format that is preceded with a legacy preamble. This traditional solution won't be possible with devices which can only operate at narrow bandwidth. To solve this problem, a trigger based data exchange is needed. To aid the narrowband devices, neighboring devices, referred to as “assisting stations (AS)”, which are in closer physical proximity to the NB devices will transmit the full 20 MHz signal, and thus transmit a legacy preamble, for the NB devices and aid in the coexistence of the narrow band devices with legacy devices. The embodiments herein provide a new staggered triggering method which performs wake-up signaling and downlink (DL)/uplink (UL) scheduling of different categories of devices (i.e., LP-NB STAs, IEEE 802.11ax STAs, AS, and legacy devices). In addition to enabling coexistence, the proposed method and system improve synchronization and power efficiency.

The methods above may use known low power solutions to inform a receiver of upcoming data packets. UL data transmission may rely on independent trigger frames. The staggered trigger method bundles wake-up signalling, synchronization through DL trigger, DL data receive, and/or UL transmission together to improve overall coexistence, power consumption, and spectrum efficiency.

Some embodiments may involve wireless communications according to one or more other wireless communication standards. Examples of other wireless communications technologies and/or standards that may be used in various embodiments may include—without limitation—other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, IEEE 802.11 ah, and/or IEEE 802.11ay standards, Wi-Fi Alliance (WFA) wireless communication standards, such as, Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any predecessors, revisions, progeny, and/or variants of any of the above.

Some embodiments may involve wireless communications performed according to one or more broadband wireless communication standards. For example, various embodiments may involve wireless communications performed according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Additional examples of broadband wireless communication technologies/standards that may be utilized in some embodiments may include—without limitation—Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS), IEEE 802.16 wireless broadband standards such as IEEE 802.16m and/or IEEE 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants.

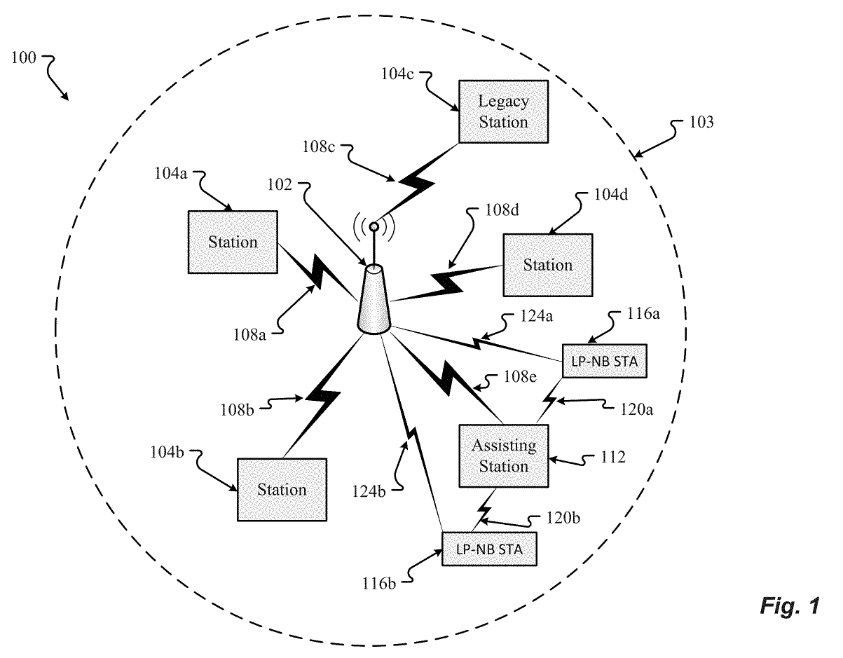

FIG. 1 illustrates an example of an operating environment 100 which may be representative of various configurations described herein. The WLAN 103 may comprise a basic service set (BSS) that may include a master station 102 and one or more other stations (STAs) 104. The master station 102 may be an access point (AP) using the IEEE 802.11 to transmit and receive. Hereinafter, the term AP will be used to identify the master station 102. The AP 102 may be a base station and may use other communications protocols as well as the IEEE 802.11 protocol. The IEEE 802.11 protocol may be the IEEE 802.11ax or later standard. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO).

The STAs 104 may include one or more high-efficiency wireless (HEW) (as illustrated in, e.g., the IEEE 802.11ax standard) STAs 104 a, b, d and/or one or more legacy (as illustrated in, e.g., the IEEE 802.11n/ac standards) STAs 104c. The legacy STAs 104c may operate in accordance with one or more of IEEE 802.11 a/b/g/n/ac/ad/af/ah/aj, or another legacy wireless communication standard. The HEW STAs 104 a, b, d may be wireless transmit and receive devices, for example, a cellular telephone, a smart telephone, a handheld wireless device, wireless glasses, a wireless watch, a wireless personal device, a tablet, or another device that may be transmitting and receiving using a IEEE 802.11 protocol, for example, the IEEE 802.11ax or another wireless protocol. In the operating environment 100, an AP 102 may generally manage access to the wireless medium in the WLAN 103.

Within the environment 100, one or more STAs 104a, 104b, 104c, 104d may associate and/or communication with the AP 102 to join the WLAN 103. Joining the WLAN 103 may enable STAs 104a-104d to wirelessly communicate with each other via the AP 102, with each other directly, with the AP 102, or to another network or resource through the AP 102. In some configurations, to send data to a recipient (e.g., STA 104a), a sending STA (e.g., STA 104b) may transmit an uplink (UL) physical layer convergence procedure (PLCP) protocol data unit (PPDU) comprising the data to AP 102, which may then send the data to the recipient STA 104a, in a downlink (DL) PPDU.

In some configurations, a frame of data transmitted between the STAs 104 or between a STA 104 and the AP 102 may be configurable. For example, a channel used in for communication may be divided into subchannels that may be 20 MHz, 40 MHz, or 80 MHz, 160 MHz, 320 MHz of contiguous bandwidth or an 80+80 MHz (160 MHz) of non-contiguous bandwidth. Further, the bandwidth of a subchannel may be incremented into 1 MHz, 1.25 MHz, 2.03 MHz, 2.5 MHz, 5 MHz and 10 MHz bandwidths, or a combination thereof, or another bandwidth division that is less or equal to the available bandwidth may also be used. The bandwidth of the subchannels may be based on a number of active subcarriers. The bandwidth of the subchannels can be 26, 52, 106, etc active subcarriers or tones that are spaced by 20 MHz. In some configurations, the bandwidth of the subchannels is 256 tones spaced by 20 MHz. In other configurations, the subchannels are 26, 52, 106, 242, 484, and 996 tones. A 20 MHz subchannel may also comprise 256 tones for use with a 256 point Fast Fourier Transform (FFT).

At a given point in time, multiple STAs 104a-d, in the WLAN 103, may wish to send data. In some configurations, rather than scheduling medium access for STAs 104a-d in different respective UL time intervals, the AP 102 may schedule medium access for STAs 104a-d to support UL multi-user (MU) transmission techniques, according to which multiple STAs 104a-d may transmit UL MU PPDUs to the AP 102 simultaneously during a given UL time interval. For example, by using UL MU OFDMA techniques during a given UL time interval, multiple STAs 104a-d may transmit UL MU PPDUs to AP 102 via different respective OFDMA resource units (RUs) allocated by AP 102. In another example, by using UL MU multiple-input multiple-output (MU-MIMO) techniques during a given UL time interval, multiple STAs 104a-d may transmit UL MU PPDUs to the AP 102 via different respective spatial streams allocated by the AP 102.

To manage access, the AP 102 may transmit a HEW master-sync transmission, which may be a trigger frame (TF) or a control and schedule transmission, at the beginning of the control period. The AP 102 may transmit a time duration of the TXOP and sub-channel information. During the HEW control period, HEW STAs 104 a, b, d may communicate with the AP 102 in accordance with a non-contention based multiple access technique such as OFDMA or MU-MIMO. This HEW technique is unlike conventional WLAN communications in which devices communicate in accordance with a contention-based communication technique, rather than a multiple access technique. During the HEW control period, the AP 102 may communicate with stations 104 using one or more control frames, and the STAs 104 may operate on a sub-channel smaller than the operating range of the AP 102. Also, during the control period, legacy stations may refrain from communicating by entering a deferral period.

During the HEW master-sync transmission, the STAs 104 may contend for the wireless medium with the legacy devices 106 being excluded from contending for the wireless medium during the HEW master-sync transmission. The trigger frame used during this HEW master-sync transmission may indicate an UL-MU-MIMO and/or UL OFDMA control period. The multiple-access technique used during the control period may be a scheduled OFDMA technique, or alternatively, may be a TDMA technique, a frequency division multiple access (FDMA) technique, or a SDMA technique.

The AP 102 may also communicate with legacy stations and/or HEW stations 104 in accordance with legacy IEEE 802.11 communication techniques. In some configurations, the AP 102 may also be configurable to communicate with HEW stations 104 outside the HEW control period in accordance with legacy IEEE 802.11 communication techniques, although this is not a requirement.

The environment 100 may also include one or more NB devices, represented by LP-NB STAs 116a,116b. LP-NB STAs 116 can represent IoT devices or other types of NB devices. The LP-NB STAs 116a, 116b receive and transmit using only a narrow bandwidth, e.g., 2 MHz. Thus, the LP-NB STAs may be assigned a particular tone or RU by the AP for DL, UL, and/or wake-up signaling. Further, the LP-NB STAs 116a, 116b may be capable of only low power transmission/reception, and therefore, the LP-NB STAs 116a, 116b may be unable to communicate directly with the AP 102 but require assistance from another STA, e.g., Assisting Station (AS) 112, to communicate with the AP 102. NB devices can be IoT devices or other types of NB devices that transmit on a NB subchannel.

The AS 112 can be the same or similar in function to the other HEW STAs 104 a, b, d. However, the AS 112 may be in physical proximity to LP-NB STAs 116a, 116b, which allows the AS 112 to communicate with the LP-NB STAs 116a, 116b. As such, the AS 112 can relay signals between the AP 102 and the LP-NB STAs 116a, 116b. The AS 112 may communicate with the LP-NB STAs 116a, 116b via a NB link 120a, 120b. The AP 102 may be able to send trigger frames and other information to the LP-NB STAs 116a, 116b via NB links 124a, 124b. However, the AP 102 may not be able to receive or transmit data or wake-up packets directly with the LP-NB STAs 116a, 116b due to the limited capabilities of the LP-NB STAs 116a, 116b.

Generally, the signalling approach in the environment is that AP 102 sends staggered wideband trigger frames prepended with a legacy preamble to frequency multiplexed NB devices 116a, 116b and time/frequency multiplexed NB 116a, 116b and wideband devices 104 in both DL and UL direction. The AP 102 can also send multiplex wake-up packets with data packets in the DL. Each NB data packet can carry a separate preamble that is can be detected and decoded by NB devices 116a, 116b. The NB devices 116a, 116b are unable to receive or transmit a wideband preamble (in particular, the 20 MHz legacy preamble), and the coexistence of these devices 116a, 116b is managed through triggers frames transmitted by the AP 102 or other AS 112. The embodiments are not limited to new devices that are narrow band exclusive. The new devices 116a, 116b also can be designed to receive and transmit a 20 MHz preamble by which the devices 116a, 116b can manage their own Clear Channel Assessment (CCA) and deferral (such a device would need less complex transmit/receive functionality relative to fully function IEEE 802.11a/g/n/ac/ax devices). Such devices might be useful for cases where the devices are at times connected to power, and then other times where the devices are limited to battery operation.

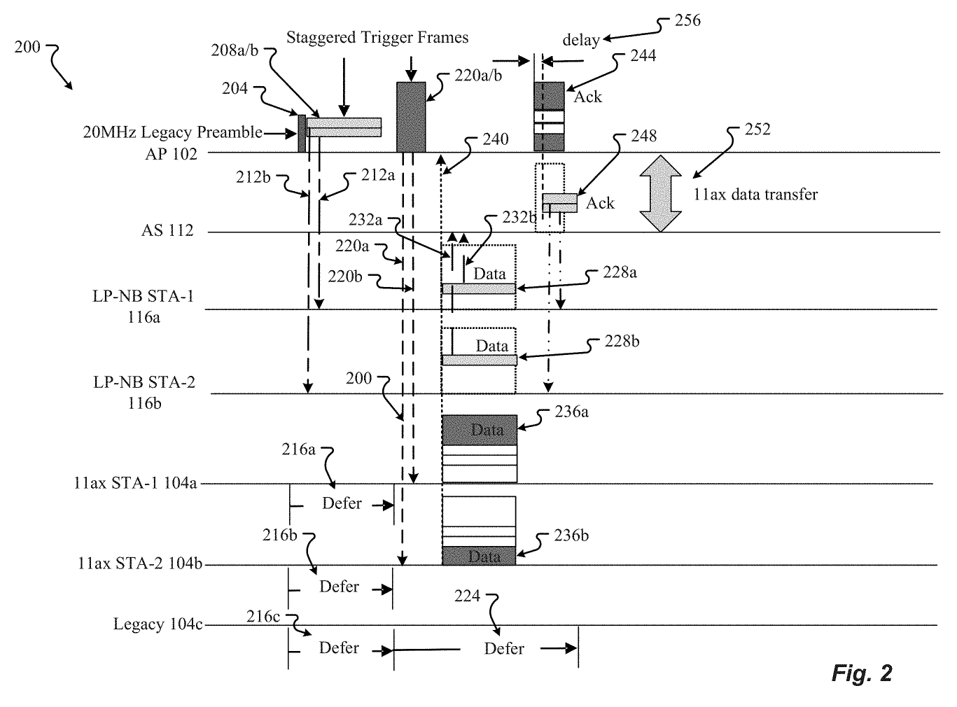

An embodiment for a signalling process 200 may be shown as in FIG. 2. The signalling process 200 can represent the UL for narrowband stations 116a, 116b transmitting data to an AP 102. In FIG. 2, the staggered triggering of frequency multiplexed NB data 208a, b may be followed by a normal IEEE 802.11ax trigger 220a, b, as shown in FIG. 2. The header of the first trigger 204 is received correctly by legacy devices 104c while decoding the content of the first trigger 204 may appear as an erroneous packet to the legacy STA 104c. Since the header 204 carries the deferral duration, the legacy STA 104c defers correctly (shown a defer 216c) and does not transmit on the media until the legacy STA 104c receives a second trigger. As shown in the FIG. 2, the AP 102 schedules and triggers NB uplink transmission along with IEEE 802.11ax OFDMA transmissions (see bandwidth separated into data RUs 228a, 228b, 236a, and 236b). The division of the bandwidth is done at the AP 102 by signalling the NB devices 116a, 116b to delay their UL transmission so the NB devices 116a, 116b are synchronized with the transmission from/to IEEE 802.11ax devices 104a, 104b.

The signalling process 200 may start with a preamble 204 sent from the AP 102 to the assisting station 104a, the narrowband stations 116a, 116b, the IEEE 802.11ax stations (referred to as the IEEE 802.11ax stations) 104a and 104b and any legacy stations 104c. The preamble causes the IEEE 802.11ax stations 104a and 104b to defer for a period of time, represented by defer 216a, 216b. Further, the Legacy station 104c defers also, represented by defer 216c. During the defer time 216, the AP102 can send trigger frames 208a, 208b to narrowband stations 116a, 116b in signals 212a and 212b. The trigger frames 208a, 208b represent the trigger for the narrowband stations 116a, 116b to send information in a 2 MHz allotment (a RU) of the bandwidth. As such, the narrowband stations 116a, 116b only conduct transmissions during or in a small part of the overall bandwidth available for transmission. Sometime thereinafter, after the defers 216a and 216b, the access point 102 can send trigger frame 220a, b, represented as signals sent as 220a and 220b, to the IEEE 802.11ax stations 104a, 104b. These trigger frames 208a, b represent the triggering for transmission of data by the IEEE 802.11ax stations 104a, 104b and provide the resource unit allocation, as shown in data transmissions 236A and 236B.

In response to the trigger frames 208a, 208b, 220a, 220b, the IEEE 802.11ax stations 104a and 104b can transmit data 236a and 236b to the access point as signals 240. The narrowband stations 116a and 116b can transmit data 228a and 228b to the AS 112, as signals 232a and 232b. The AS 112 may then acknowledge those transmissions through ack packet(s) 248 sent to both the narrowband stations 116a and 116b. The acknowledgement packets 248a and b are sent just to the narrowband stations from the assisting station 112. Further acknowledgements 244 may be sent by the access point 102 around the same time as acknowledgements 248 a and 248b to the IEEE 802.11ax stations 104a and 104b. There needs to be an offset in time (shown by delay 256 in FIG. 2) of transmission of the ack 244 and then the ack 248 to allow for a legacy preamble to be transmitted first. Sometime thereinafter during further IEEE 802.11ax data transfers 252, the assisting station 112 can transmit the data in 228a, 228b to the access point 102.

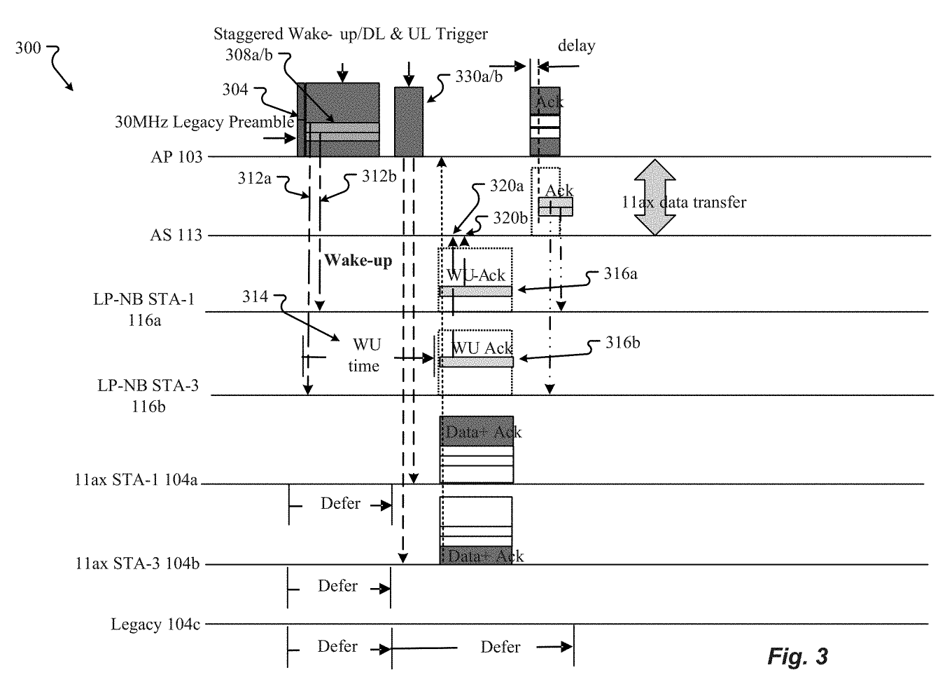

A further signalling process 300 for causing the narrowband stations 116a, 116b to wake up is shown in FIG. 3. Wake-up packet transmissions are multiplexed as a NB transmission 312a, 312b along with other IEEE 802.11ax DL OFDMA transmissions 304. FIG. 3 shows that after receiving a wake-up packet 308a, b, the LP-NB STAs 116a, 116b transmits back a wake-up acknowledgement (ack 316a, 316b). It should be noted that the ack is not a requirement and the protocol may not mandate an ack to a wake-up packet. In this case, the AP 102 can schedule other uplink transmission in those slots.

The process 300 may also begin with a preamble 304 and wake-up packets 308a and 308b, sent as signals 312a and 312b, to narrowband stations 116a and 116b. These wake-up packets 308a and 308b cause the wake-up receivers of the narrowband stations to wake up the main radios. The main radio, which has transitioned to the awake mode and may have aligned its IEEE 802.11ax transmissions, will then wait to transmit during time 314. Upon waking up the narrowband stations 116a and 116b send wake-up acknowledgements 316a and 316b, as signals 320a and 320b, to the AS 112. The AS 112 may send acks back to the LP-NB STAs 116a 116b, which is a similar process to signal 248 sent to narrowband station 116a and 116b in FIG. 2. Thereinafter, the AS 112 may alert the AP 102 that the narrowband stations 116a and 116b are awake and can receive or send data. If receiving data, the process 300 may proceed similar to the process 200 shown of FIG. 2.

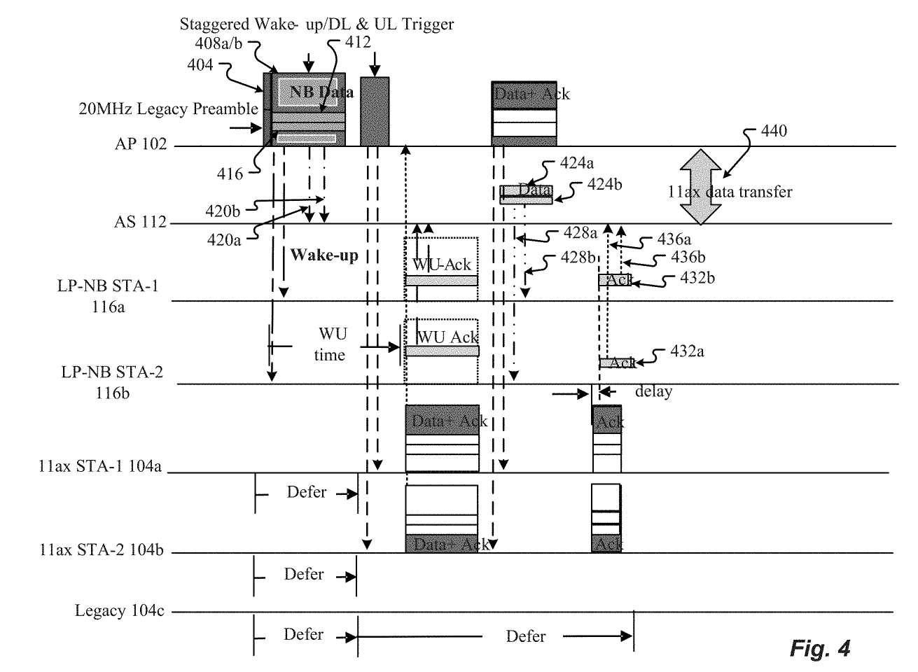

An embodiment for a data download process 400 may be as shown in FIG. 4. FIG. 4 shows a case where DL NB data 408a, b is multiplexed with the wake-up packets 412, 416 in addition to the DL/UL schedule. The AS 112 buffers the DL data for the NB devices 116a, 116b until the NB devices 116a, 116b return from sleep mode, and then transmits their respective DL data 424a, 424b to these NB devices 116a, 116b based on the schedule defined in the staggered trigger frame 404.

Data download 400 may also begin with a staggered trigger frame 404, having a preamble, and wake-up packets 412, 416, similar to that shown in FIG. 3, sent in signals to narrowband station 116a and 116b. However, the staggered trigger frame 404 may also include narrowband data 408a, 408b, possibly embedded in an 11ax OFDMA transmission, which may be sent to the AS 112, as signals 420a and 420b.

There may be other information provided beyond the wake-up packets 412 and 416 sent to the narrowband stations 116a, 116b, such as which AS 112 will provide the data. After a wake-up time, the wake-up acknowledgments are sent back to the AS 112, which then transmits the narrowband data 424a, 424b received from the AP 102 as signals 428a and 428b to narrowband stations 116a and 116b. Upon receiving the data, the narrowband stations 116a and 116b may then send acknowledgments 432a and 432b, in signals 436a and 436b, back to the AS 112. The AS 112 may then transfer the acks to the AP 102 during further IEEE 802.11ax data transfers 440.

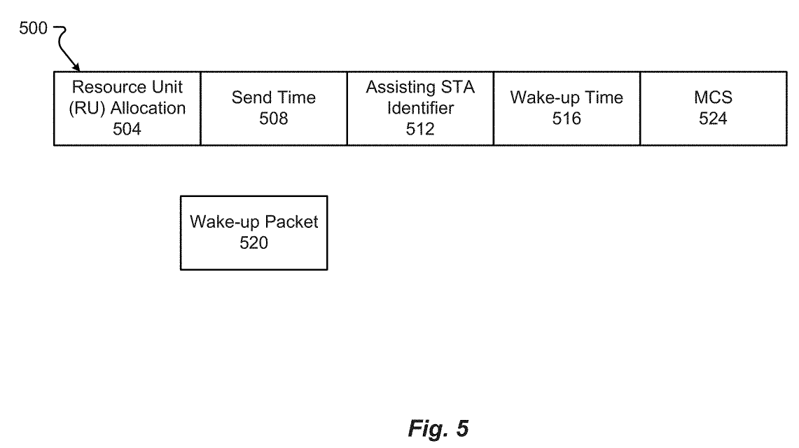

An embodiment of signalling data 500, which may be transmitted between the AP 102, the AS 112, and one or more narrowband stations 116a, 116b may be as shown in FIG. 5. The data 500 described herein may be part of the trigger preamble (e.g., preamble 204), the trigger frame (e.g., trigger frame data 208), or one or more wake-up packets ( ). In various configurations, the data 500 may include one or more of, but is not limited to, the resource unit allocation 504, the transmit time 508, the assisting station identifier 512, the wake-up time 516, and/or the modulation of coding scheme information 524. The wake-up packet 520 can be a separate and independent transmission.

The resource unit (RU) allocation 504 can provide the information for which 2 MHz narrowband frequency the narrowband station 116a, 116b is to use. This RU allocation can be assigned for the next transmission or may persist for a period of time. For example, the resource-unit allocation 504 may exist for some time period, such as one hour, or for a number of exchanges, for example, the next 10 exchanges. The above information may all be included in the resource-unit allocation field 504.

The send time or transmit time 508 can be the indication, for the narrowband station 116a and 116b, when to start transmitting data to the AS 112. The send time 508 can ensure that the narrowband stations 116a and 116b send data in a time that correlates to the time that the IEEE 802.11ax stations 104a, 104b also transmit data, as shown in FIGS. 2 and 3. The transmit time 508 can be an amount of time the LP-NB STAs 116 should after receiving the trigger frame. In other configurations, the transmit time 508 may be a discreet time based on a common clock that the narrowband stations 116a, 116b should transmit.

The assisting station ID 512 can be the identifier for AS 112 that identifies the AS 112 for the narrowband stations 116a, 116b. The assisting station ID 512 may be provided by the AP 102 or may be established through some other methods conducted between the AS 112 and the narrowband stations 116a, 116b. The assisting station ID 512 may be any type of identifier including a globally unique identifier (GUID), an alphanumeric identifier, etc.

The wake-up time 516 can be the amount of time allotted 314 for the narrowband stations 116a, 116b to wake up after transmission of a wake-up packet 312A, 312B. The wake-up time 516 can set a time to start waking up the main radio, to which wake-up radio is accompanied or can establish the amount of time allotted to wake up the radio. As such, the wake-up time 516 allows for the latency of the narrowband stations 116a, 116b to wake up the main radio and contend for bandwidth.

The wake-up packet 520 is the wake-up packet 308a, b or signal sent to the narrowband station's wake-up radio as signals 312A and 312B. This signal 308 may be a simple signal to simply indicate to the narrowband stations 116a and 116b to begin waking up the main radio. The IEEE 802.11 standard working group is in process of defining the wake-up packet 520.

The MCS 524 can be any information about what type of modulation or coding schemes may be used in transmitting data from the narrowband stations 116a, 116b to the AS 112 and/or how data will be transferred from an AP 102 to the narrowband stations 116a, 116b. These modulation/coding schemes 524 can include such things as whether BPSK, QPSK, or some other type of coding or modulation may be used, etc.

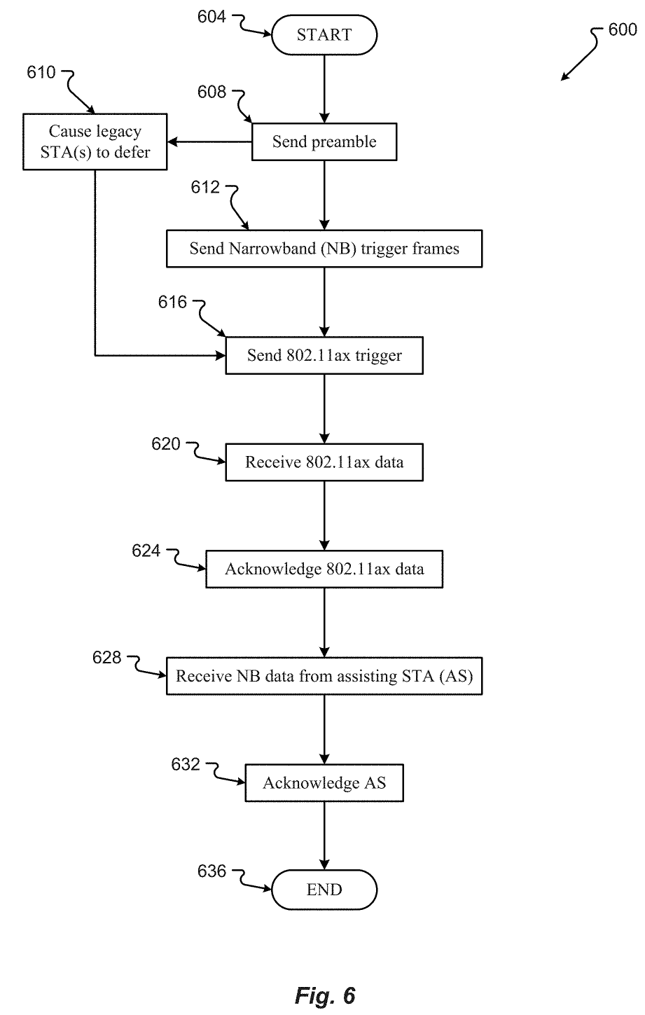

An embodiment of a method for an AP 102 to receive upload data from LP-NB STAs 116 may be as shown in FIG. 6. The method 600 can be understood with relation to FIG. 2 previously described. The method 600 may be from the perspective of the AP 102. A general order for the steps of the method 600 is shown in FIG. 6. Generally, the method 600 starts with a start operation 604 and ends with an end operation 636. The method 600 can include more or fewer steps or can arrange the order of the steps differently than those shown in FIG. 6. The method 600 can be executed as a set of computer-executable instructions executed by a computer system or processor and encoded or stored on a computer readable medium. Hereinafter, the method 600 shall be explained with reference to the systems, components, circuits, modules, software, data structures, signalling processes, etc. described in conjunction with FIGS. 1-5 and 15.

The AP 102 can send a preamble 204, in step 608. The preamble to 204 can be a 20-megahertz preamble causing the IEEE 802.11ax stations 104a, 104b and legacy station 104c to defer, for time 216, in step 910. Thereinafter, the AP 102 may send a narrowband trigger 208, in step 612. The narrowband trigger 208 can contain information 500, as described in conjunction with FIG. 5. This trigger frame 208 may be sent to narrowband stations 116a, 116b.

After sending the trigger frames 208, the AP 102 can send the IEEE 802.11ax trigger frame 220 to the IEEE 802.11ax stations 104a, 104b, in step 616. The IEEE 802.11ax trigger 220 can include information as understood in the art with the IEEE 802.11ax standard. As can be seen in FIG. 2, the trigger 220 occurs after trigger 208, and thus, the triggers 208, 220 are staggered.

In response to the trigger 220, sent in step 616, the AP 102 can receive the IEEE 802.11ax data 236 from the IEEE 802.11ax stations 104a, 104b, in step 620; in response to receiving that data, the AP 102 may send an ack 244, in step 624. The data 236 and ack 244 may be sent in defined RU allocations (shown as the shaded regions in data 236 and ack 244 of FIG. 2) that allows for the simultaneous transmission of data 228 during the transmission of data 236, in step 620. Further, acks 244 may also be restricted to certain RU allocations to allow for acks 248 to be sent simultaneously.

Sometime after sending the acknowledgements in step 624, the AP 102 can receive narrowband data 228 from the AS 112, in step 628 (see transmission(s) 252 in FIG. 2). This narrowband data 228 will have been transferred at the same time that IEEE 802.11ax data 236 was sent in step 620. The NB data 228 may then be further sent to other entities by the AP 102. The AP 102 may acknowledge the AS 112 with respect to the transmission of data, in step 632.

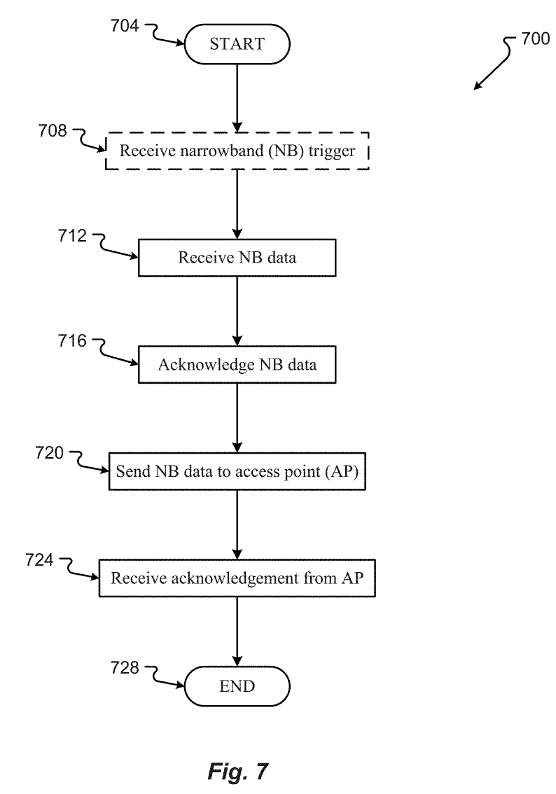

An embodiment of uploading data from a perspective of the AS 112 may be as shown in FIG. 7. The method 700 can also be understood with relation to FIG. 2 previously described. The method 700 may be from the perspective of the AS 112. A general order for the steps of the method 700 is shown in FIG. 7. Generally, the method 700 starts with a start operation 704 and ends with an end operation 728. The method 700 can include more or fewer steps or can arrange the order of the steps differently than those shown in FIG. 7. The method 700 can be executed as a set of computer-executable instructions executed by a computer system or processor and encoded or stored on a computer readable medium. Hereinafter, the method 700 shall be explained with reference to the systems, components, circuits, modules, software, data structures, signalling processes, etc. described in conjunction with FIGS. 1-6 and 15.

The AS 112 can receive the narrowband trigger 208, in step 708. The reception of the trigger is optional, but may alert the AS 112 that narrowband data may be sent to AS 112. The AS 112 may receive narrowband data 228, in step 712. As shown in FIG. 2, the narrowband data 228 may be sent signals 232 to the AS 112. The AS 112 may receive and buffer the data for later transmission to the AP 102. In response to receiving the narrowband data signals 232, the AS 112 may send ack packet(s) 248 back to the LP-NB STAs 116a, 116b, in step 716.

Thereinafter, the AS 112 can send the buffered NB data 228 to the AP 102 in step 720 (shown as transmissions 252 in FIG. 2). These transmissions 252 may be conducted according to the IEEE 802.11ax standard. In response to the data transfer, the AS 112 can receive an ack from the AP 102, in step 724. The ack acknowledges the transmission of the narrowband data to the AP 102.

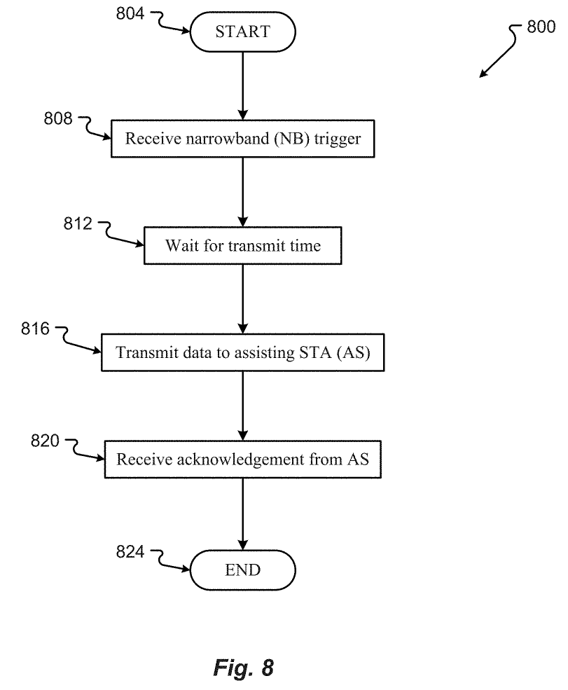

An embodiment of uploading data from the perspective of LP-NB STA(s) 116a, 116b may be as shown in FIG. 8. The method 800 can also be understood with relation to FIG. 2 previously described. The method 800 may be from the perspective of the LP-NB STA(s) 116a, 116b. A general order for the steps of the method 800 is shown in FIG. 8. Generally, the method 800 starts with a start operation 804 and ends with an end operation 824. The method 800 can include more or fewer steps or can arrange the order of the steps differently than those shown in FIG. 8. The method 800 can be executed as a set of computer-executable instructions executed by a computer system or processor and encoded or stored on a computer readable medium. Hereinafter, the method 800 shall be explained with reference to the systems, components, circuits, modules, software, data structures, signalling processes, etc. described in conjunction with FIGS. 1-7 and 15.

The LP-NB STA(s) 116a, 116b may receive a narrowband trigger 208, sent from the AP 102, in step 808. Upon receiving the trigger 208, the LP-NB STA(s) 116a, 116b may wait some period of time, in step 812, to time-align their data transmissions 232 with the IEEE 802.11ax station(s) 104a and 104b transmissions to the AP 102. The LP-NB STA(s) 116a, 116b can then transmit data 228, to an AS 112, in step 816. As discussed previously, the transmissions 232 may be in a narrowband RU 228a and 228b (shown as smaller boxes 228 in FIG. 2) that were identified in the data 500 sent as trigger frame 208, described in conjunction with FIG. 5. The data is sent as signals 232 to the assisting station 112. Sometime thereinafter, the LP-NB STA(s) 116a, 116b can receive an ack 248 from the AS 112, in step 820. The ack packet 248 may be sent to the LP-NB STA(s) 116a, 116b in response to transmitting the data 228 to the AS 112.

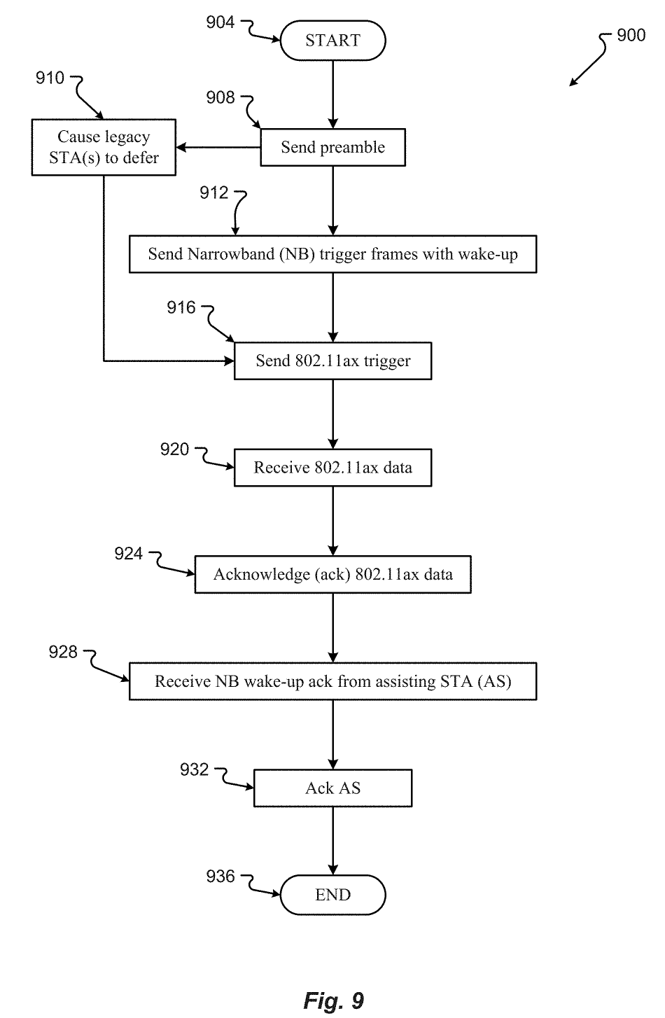

An embodiment of a method for an AP 102 to send wake-up packets to LP-NB STA(s) 116a, 116b may be as shown in FIG. 9. The method 900 can be understood with relation to FIG. 3 previously described. The method 900 may be from the perspective of the AP 102. A general order for the steps of the method 900 is shown in FIG. 9. Generally, the method 900 starts with a start operation 904 and ends with an end operation 936. The method 900 can include more or fewer steps or can arrange the order of the steps differently than those shown in FIG. 9. The method 900 can be executed as a set of computer-executable instructions executed by a computer system or processor and encoded or stored on a computer readable medium. Hereinafter, the method 900 shall be explained with reference to the systems, components, circuits, modules, software, data structures, signalling processes, etc. described in conjunction with FIGS. 1-8 and 15.

The AP 102 can send a preamble 304, in step 908. The preamble to 304 can be a 20-megahertz preamble causing the IEEE 802.11ax stations 104a, 104b and legacy station 104c to defer, for time 216, in step 910. Thereinafter, the AP 102 may send a narrowband trigger with a wake-up packet 308, in step 912. The narrowband trigger 308 can contain information 500, including the wake-up packet 520, as described in conjunction with FIG. 5. This trigger frame 308 may be sent to LP-NB STAs 116a, 116b.

After sending the trigger frames 308, the AP 102 can send the IEEE 802.11ax trigger frame 330 to the IEEE 802.11ax stations 104a, 104b, in step 916. The IEEE 802.11ax trigger 330 can include information as understood in the art with the IEEE 802.11ax standard. As can be seen in FIG. 3, the trigger 330 occurs after trigger 208, and thus, the triggers 308, 330 are staggered.

In response to the trigger 330, sent in step 916, the AP 102 can receive the IEEE 802.11ax data 236 from the IEEE 802.11ax stations 104a, 104b, in step 920; in response to receiving that data, the AP 102 may send an ack 244, in step 924. The data 236 and ack 244 may be sent in defined RU allocations (shown as the shaded regions in data 236 and ack 244 of FIG. 2) that allows for the simultaneous transmission of ack 316 during the transmission of data 236, in step 920. Further, acks 244 may also be restricted to certain RU allocations to allow for acks 248 to be sent simultaneously.

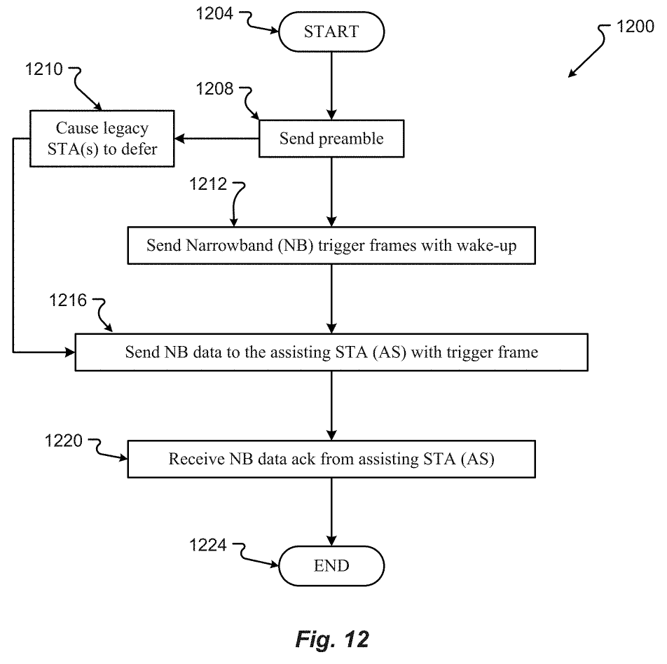

Sometime after sending the acknowledgements in step 924, the AP 102 can receive narrowband wake-up ack 316 from the AS 112, in step 928 (see transmission(s) 252 in FIG. 2). This NB wake-up ack 316 will have been transferred at the same time that IEEE 802.11ax data 239 was sent in step 920. The AP 102 may acknowledge the AS 112 with respect to the transmission of NB wake-up acks 316, in step 932. The AP 102 may then proceed to receive or send data to the LP-NB STA(s) 116a, 116b, as described in FIGS. 6 and 12.

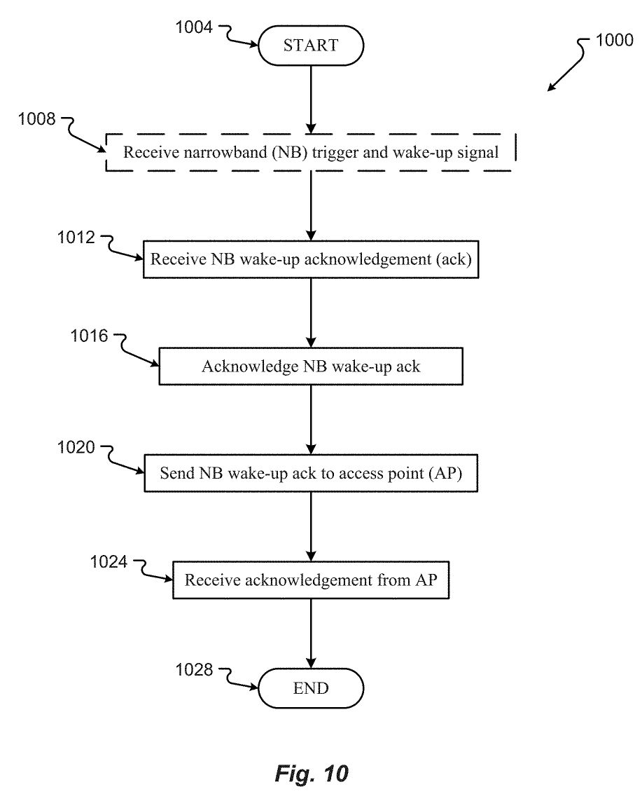

An embodiment of method for an AS 112 to send wake-up packets to LP-NB STA(s) 116a, 116b may be as shown in FIG. 10. The method 1000 can be understood with relation to FIG. 3 previously described. The method 1000 may be from the perspective of the AS 112. A general order for the steps of the method 1000 is shown in FIG. 10. Generally, the method 1000 starts with a start operation 1004 and ends with an end operation 1028. The method 1000 can include more or fewer steps or can arrange the order of the steps differently than those shown in FIG. 10. The method 1000 can be executed as a set of computer-executable instructions executed by a computer system or processor and encoded or stored on a computer readable medium. Hereinafter, the method 1000 shall be explained with reference to the systems, components, circuits, modules, software, data structures, signalling processes, etc. described in conjunction with FIGS. 1-9 and 15.

The AS 112 can receive the narrowband trigger with the wake-up packet 308, in step 1008. The reception of the trigger is optional, but may alert the AS 112 that a wake-up packet 520 has been sent by the AP 102. The AS 112 may receive NB wake-up acks 316, in step 1012. As shown in FIG. 3, the NB wake-up acks 316 may be sent signals 320 to the AS 112. The AS 112 may receive and buffer the NB wake-up acks 316 for later transmission to the AP 102. In response to receiving the NB wake-up acks 316, the AS 112 may send ack packet(s) back to the LP-NB STAs 116a, 116b, in step 1016.

Thereinafter, the AS 112 can send the NB wake-up acks 316 to the AP 102, in step 1020. These transmissions may be conducted according to the IEEE 802.11ax standard. In response to the transfer of the NB wake-up acks 316, the AS 112 can receive an ack from the AP 102, in step 1024. The ack acknowledges the transmission of the NB wake-up acks 316 to the AP 102.

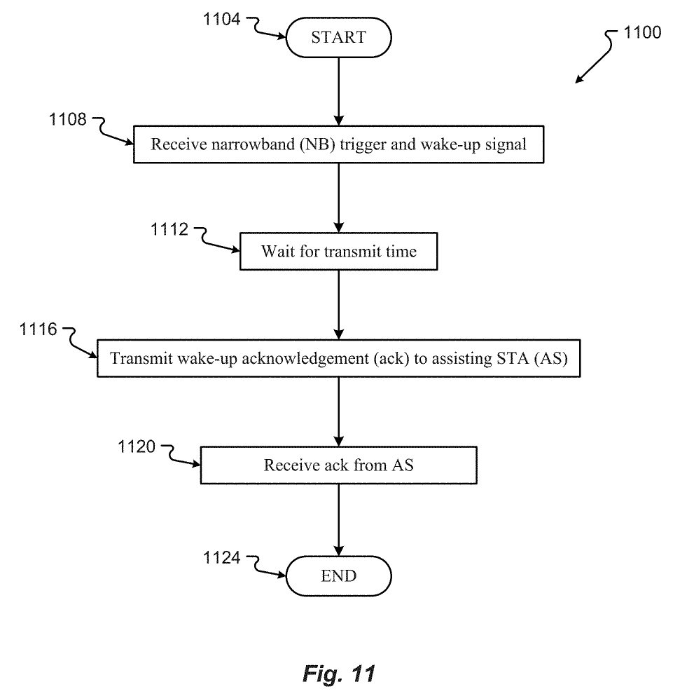

An embodiment of method for LP-NB STA(s) 116a, 116b to receive wake-up packets may be as shown in FIG. 11. The method 1100 can be understood with relation to FIG. 3 previously described. The method 1100 may be from the perspective of the LP-NB STA(s) 116a, 116b. A general order for the steps of the method 1100 is shown in FIG. 11. Generally, the method 1100 starts with a start operation 1104 and ends with an end operation 1124. The method 1100 can include more or fewer steps or can arrange the order of the steps differently than those shown in FIG. 11. The method 1100 can be executed as a set of computer-executable instructions executed by a computer system or processor and encoded or stored on a computer readable medium. Hereinafter, the method 1100 shall be explained with reference to the systems, components, circuits, modules, software, data structures, signalling processes, etc. described in conjunction with FIGS. 1-10 and 15.

The wake-up receiver of the LP-NB STA(s) 116a, 116b may receive a narrowband wake-up transmission 308, with a wake-up packet 520, sent from the AP 102, in step 1108. Upon receiving the wake-up 308, the LP-WUR 1560, of LP-NB STA(s) 116a, 116b, signals the main wireless radio 1570 of LP-NB STA 116 to transition from the sleep mode to the awake mode. This transition requires NB devices to wait some period of time to awaken, in step 1112. Further, the main wireless radio 1570 may time-align their transmissions 320 with the IEEE 802.11ax station(s) 104a and 104b transmissions to the AP 102, during the wait time in step 1112. The main wireless radio 1570 LP-NB STA(s) 116a, 116b can then transmit NB wake-up ack 316, to an AS 112, in step 1116. As discussed previously, the transmissions 320 may be in a narrowband RU 316a and 316bb (shown as smaller boxes 316 in FIG. 3) that were identified in the data 500 sent as a previous trigger frame 208, described in conjunction with FIG. 2 and FIG. 5. The NB wake-up ack 316 is sent as signals 320 to the AS 112. Sometime thereinafter, the LP-NB STA(s) 116a, 116b can receive an ack from the AS 112, in step 1120. The ack packet may be sent to the LP-NB STA(s) 116a, 116b in response to transmitting the NB wake-up ack 316 to the AS 112.

An embodiment of a method 1200 for conducting data downloads with LP-NB STA(s) 116a, 116b may be as shown in FIG. 12. The method 1200 can be understood with relation to FIG. 4 previously described. The method 1200 may be from the perspective of the AP 102. A general order for the steps of the method 1200 is shown in FIG. 12. Generally, the method 1200 starts with a start operation 1204 and ends with an end operation 1224. The method 1200 can include more or fewer steps or can arrange the order of the steps differently than those shown in FIG. 12. The method 1200 can be executed as a set of computer-executable instructions executed by a computer system or processor and encoded or stored on a computer readable medium. Hereinafter, the method 1200 shall be explained with reference to the systems, components, circuits, modules, software, data structures, signalling processes, etc. described in conjunction with FIGS. 1-11 and 15.

The AP 102 may send a preamble 404, in step 1208. The preamble may be a 20-megahertz preamble that causes the IEEE 802.11ax stations 104a, 104b and the legacy station 104c to defer for some period of time 216. Thereinafter, the AP 102 may send a NB trigger 408 with a wake-up packet packets 412, 416 to one or more narrowband stations 116a, 116b, in step 1212. The wake-up packet packets 412, 416 alert the main radio(s) of LP-NB STA(s) 116a, 116b that data downloads are imminent and to expect them on a RU allocation as provided in previous frame exchanges.

The AP 102 may also send narrowband data in the trigger frame 408 to the AS 112, in step 216. This data exchange between AP and AS can be done in IEEE 802.11ax format and hence the NB data will be embedded in an IEEE 802.11ax OFDMA allocation. Here, the AP 102 sends the NB data to the AS 112, rather than sending the data directly to the LP-NB STA(s) 116a, 116b. However, it is possible that the AP 102 may be able to send data directly to the LP-NB STA(s) 116a, 116b in NB format in some configurations.

Sometime thereinafter the AS 112 may send an ack signal to the AP 102, in step 1220. The ack may be an acknowledgement from the AS 112 that the NB data was received and an acknowledgement that the AS 112 will then transmit the NB data to the LP-NB STA(s) 116a, 116b in a subsequent transmission.

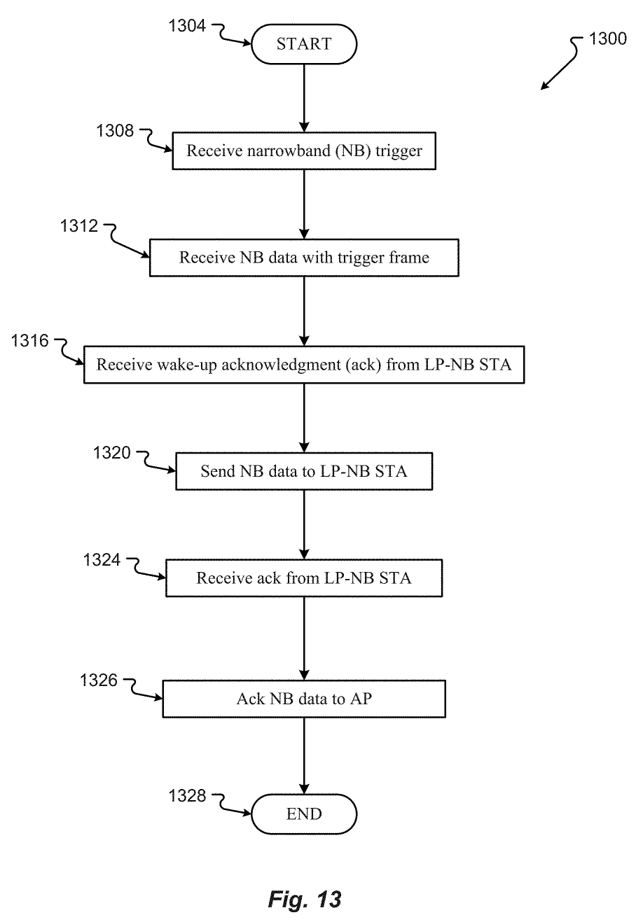

An embodiment of a method 1300 for conducting data downloads with LP-NB STA(s) 116a, 116b may be as shown in FIG. 13. The method 1300 can also be understood with relation to FIG. 4 previously described. The method 1300 may be from the perspective of the AS 112. A general order for the steps of the method 1300 is shown in FIG. 13. Generally, the method 1300 starts with a start operation 1304 and ends with an end operation 1328. The method 1300 can include more or fewer steps or can arrange the order of the steps differently than those shown in FIG. 13. The method 1300 can be executed as a set of computer-executable instructions executed by a computer system or processor and encoded or stored on a computer readable medium. Hereinafter, the method 1300 shall be explained with reference to the systems, components, circuits, modules, software, data structures, signalling processes, etc. described in conjunction with FIGS. 1-12 and 15.

The AS 112 may receive a trigger with NB data 408 from the AP 102, in step 1308. The narrowband data 408 is to be sent onto the narrowband stations 116a, 116b. This trigger frame and narrowband data 408 may include the data, as described in conjunction with FIG. 5, for conducting a later transmission over certain allocated RUs. The AS 112 may then receive the narrowband data from the AP 102, in step 1312 and buffer that data for later transmission to the LP-NB STA(s) 116a, 116b.

Sometime thereinafter, the AS 112 may receive the wake-up acknowledgement from the LP-NB STA(s) 116a, 116b, in step 316. The wake-up ack acknowledges that the wake-up packet 520, sent from the AP 102 in the trigger frame, was received and the AS 112 may repeat the ack to the AP 102. Receipt of the wake-up ack signal indicates that the data may be transmitted to the LP-NB STA(s) 116a, 116b thereinafter.

The AS 112 may then send the narrowband data to the LP-NB STA(s) 116a, 116b, in step 1320. Here, the data 324 may be sent in signals 428 to the LP-NB STA(s) 116a, 116b. In response, the LP-NB STA(s) 116a, 116b may send acks 432 as signals 436 back to the receiving AS 112, in step 324. The acks 432 may then be provided to the AP 102 by the AS 112 in some configurations.

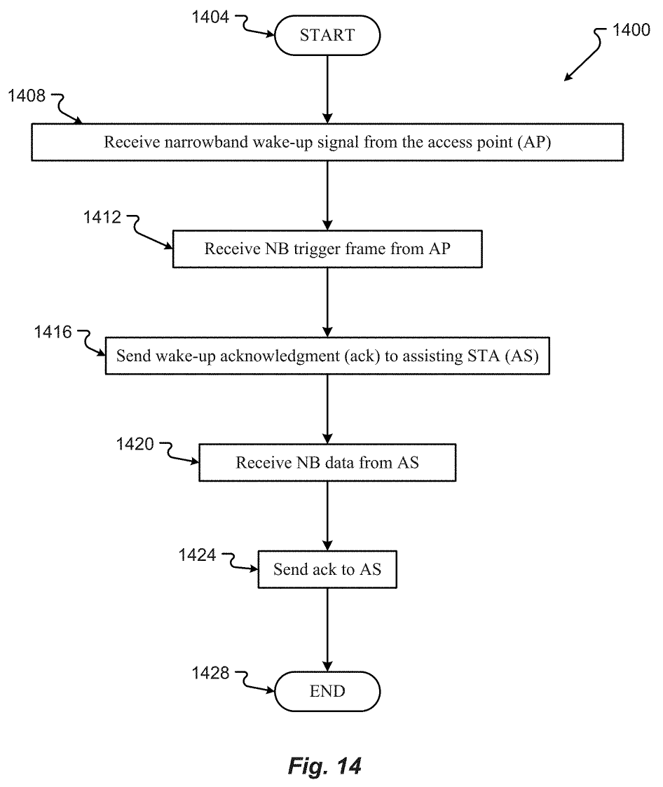

An embodiment of a method 1400 for receiving data a LP-NB STA(s) 116a, 116b may be as shown in FIG. 14. The method 1400 can also be understood with relation to FIG. 4 previously described. The method 1400 may be from the perspective of the LP-NB STA(s) 116a, 116b. A general order for the steps of the method 1400 is shown in FIG. 14. Generally, the method 1400 starts with a start operation 1404 and ends with an end operation 1428. The method 1400 can include more or fewer steps or can arrange the order of the steps differently than those shown in FIG. 14. The method 1400 can be executed as a set of computer-executable instructions executed by a computer system or processor and encoded or stored on a computer readable medium. Hereinafter, the method 1400 shall be explained with reference to the systems, components, circuits, modules, software, data structures, signalling processes, etc. described in conjunction with FIGS. 1-13 and 15.

The LP-NB STA(s) 116a, 116b may receive a wake-up packet(s) 412, 416, in step 1408. The wake-up packet(s) 412, 416 may be sent from the AP 102 and may be as described in conjunction with FIG. 3. Thus, the wake-up packet(s) 412, 416 may also receive wake-up from the AP 102 as described in conjunction with FIGS. 2-4.

Upon receiving the wake-up packet(s) 412, 416 and in response thereto, the LP-NB STA(s) 116a, 116b may wait a period of time, as described in conjunction with FIG. 3, before sending wake-up acks 316, in step 416. The wake-up acks 416 may be sent as signals 320 to the AS 112. The wake-up acks 316 may be interpreted as ready to receive signals by the AS 112, which received the narrowband data from the AP 102 in previous transmission, as explained in FIGS. 12 and 13.

Thereinafter, the LP-NB STA(s) 116a, 116b can receive the narrowband data 424 from the AS 112, in step 420. The data 424 is sent in signals 420 to LP-NB STA(s) 116a, 116b after the wake-up ack signals. The data 424 may be received and then acknowledged, in step 1424 by the LP-NB STA(s) 116a, 116b in ack packets 432. The ack packets 432 may be sent to the AS 112 in signals 436 for later possible transmission to the AP 102.

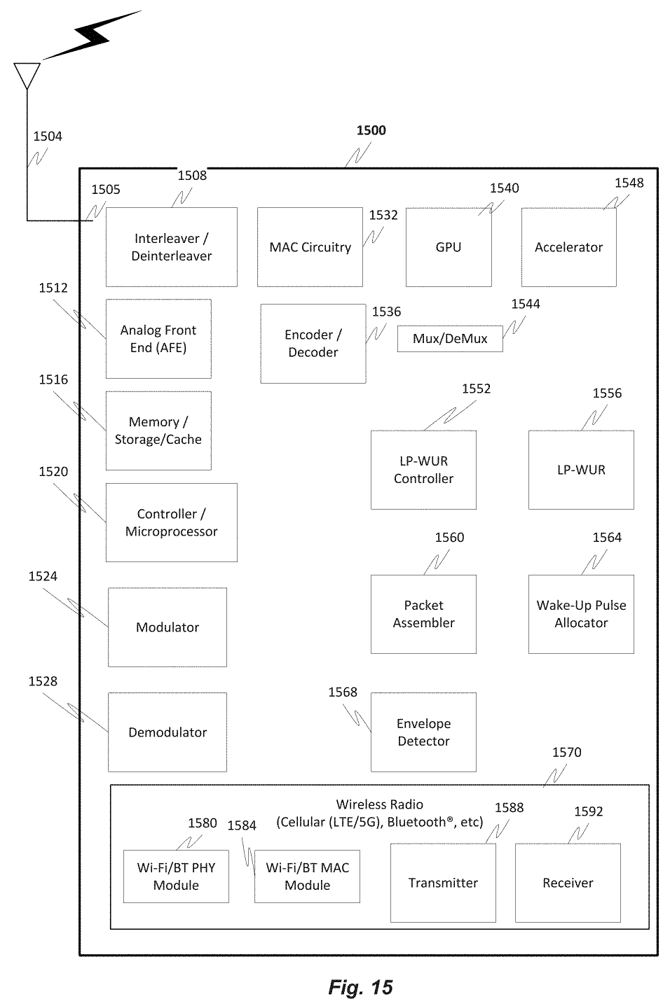

FIG. 15 illustrates an exemplary hardware diagram of a device 1500, such as a LP-NB STA(s) 116a, 116b, AP 102, AS 112 STAs 104, or the like, that is adapted to implement the technique(s) discussed herein.

In addition to well-known componentry (which has been omitted for clarity), the device 1500 includes interconnected elements including one or more of: one or more antennas 1504, an interleaver/deinterleaver 1508, an analog front end (AFE) 1512, memory/storage/cache 1516, controller/microprocessor 1520, MAC circuitry 1532, modulator 1524, demodulator 1528, encoder/decoder 1536, GPU 1540, accelerator 1548, a multiplexer/demultiplexer 1544, LP-WUR controller 1552, LP-WUR 1556, packet assembler 1560, wake-up pulse allocator 1564, envelope detector 1568 and wireless radio 15150 components such as a Wi-Fi PHY module/circuit 1580, a Wi-Fi/BT MAC module/circuit 1584, transmitter 1588 and receiver 1592. The various elements in the device 1500 are connected by one or more links/connections (not shown, again for sake of clarity).

The device 1500 can have one more antennas 1504, for use in wireless communications such as Wi-Fi, multi-input multi-output (MIMO) communications, multi-user multi-input multi-output (MU-MIMO) communications Bluetooth®, LTE, 5G, 60 Ghz, WiGig, mmWave systems, etc. The antenna(s) 1504 can include, but are not limited to one or more of directional antennas, omnidirectional antennas, monopoles, patch antennas, loop antennas, microstrip antennas, dipoles, and any other antenna(s) suitable for communication transmission/reception. In one exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 1504 generally interact with the Analog Front End (AFE) 1512, which is needed to enable the correct processing of the received modulated signal and signal conditioning for a transmitted signal. The AFE 1512 can be functionally located between the antenna and a digital baseband system in order to convert the analog signal into a digital signal for processing, and vice-versa.

The device 1500 can also include a controller/microprocessor 1520 and a memory/storage/cache 1516. The device 1500 can interact with the memory/storage/cache 1516 which may store information and operations necessary for configuring and transmitting or receiving the information described herein. The memory/storage/cache 1516 may also be used in connection with the execution of application programming or instructions by the controller/microprocessor 1520, and for temporary or long term storage of program instructions and/or data. As examples, the memory/storage/cache 1520 may comprise a computer-readable device, RAM, ROM, DRAM, SDRAM, and/or other storage device(s) and media.

The controller/microprocessor 1520 may comprise a general purpose programmable processor or controller for executing application programming or instructions related to the device 1500. Furthermore, the controller/microprocessor 1520 can cooperate with one or more other elements in the device 1500 to perform operations for configuring and transmitting information as described herein. The controller/microprocessor 1520 may include multiple processor cores, and/or implement multiple virtual processors. Optionally, the controller/microprocessor 1520 may include multiple physical processors. By way of example, the controller/microprocessor 1520 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 1500 can further include a transmitter 1588 and receiver 1592 which can transmit and receive signals, respectively, to and from other wireless devices and/or access points using the one or more antennas 1504. Included in the device 1500 circuitry is the medium access control or MAC Circuitry 1532. MAC circuitry 1532 provides for controlling access to the wireless medium. In an exemplary embodiment, the MAC circuitry 1532 may be arranged to contend for the wireless medium and configure frames or packets for communicating over the wireless medium.

The device 1500 can also optionally contain a security module (not shown). This security module can contain information regarding but not limited to, security parameters required to connect the device to an access point or other device, or vice versa, or other available network(s), and can include WEP or WPA/WPA-2 (optionally+AES and/or TKIP) security access keys, network keys, etc. As an example, the WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

The exemplary device 1500 can also include a GPU 1540, an accelerator 1548, multiplexer/demultiplexer 1544, a Wi-Fi/BT/BLE PHY module 1580 and a Wi-Fi/BT/BLE MAC module 1584 that at least cooperate with one or more of the other components as discussed herein. In operation, exemplary behavior of a wireless system commences with the transmitter side of a communication system including, for example, two or more of the wireless devices 1500.

When it is determined that wake-up of a main radio is required, the LP-WUR controller 1552, communicating with the packet assembler 1560, wake-up pulse allocator 1564, controller 1520 and memory 1516 assemble a wake-up pulse for a wake-to packet to be transmitted to a receiving transceiver, to wake-up the main radio of the receiving transceiver.

As discussed, the packet assembler 1560 and wake-up pulse allocator 1564 allocate the wake-up pulse to the approximate center of the band without nulling the central subcarriers around DC. The LP-WUR controller 1552, communicating with the packet assembler 1560, wake-up pulse allocator 1564, controller 1520 and memory 1516 also allocate guard bands around the wake-up pulse.

The LP-WUR controller 1552, communicating with the packet assembler 1560, wake-up pulse allocator 1564, controller 1520 and memory 1516 then allocate subcarrier indices corresponding to IEEE 802.11ax RUs.

The transmitter 1588 then transmits the wake-up packet.

At the receiving transceiver, the LP-WUR 1556 receives the wake-up packet. Demodulator 1528 demodulates the received wake-up packet and uses the envelope detector 1568 to detect the wake-up pulse in the wake-up packet. The LP-WUR 1556 then triggers the wake-up of one or more wireless radio components 1570-1592.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments are described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless access point comprising: a memory; a processor in communication with the memory, the processor to: send a narrowband (NB) trigger frame to a low-power NB station (LP-NB STA); along with the trigger frame, send NB data to an assisting station (AS); in response to sending the NB data, receive a first acknowledgement (ack) from the AS; send an IEEE 802.11ax trigger frame to an IEEE 802.11ax station (STA); send IEEE 802.11ax data to the IEEE 802.11ax STA; and in response to sending the IEEE 802.11ax data, receive a second ack from the IEEE 802.11ax STA.

Any one or more of the above aspects, wherein the processor is further to send a legacy preamble before the NB trigger frame, wherein the legacy preamble causes a legacy STA to defer while the NB data is sent.

Any one or more of the above aspects, wherein, in response to the legacy preamble, the IEEE 802.11ax STA defers while the AP sends the NB trigger frame.

Any one or more of the above aspects, wherein the IEEE 802.11ax trigger frame causes the legacy STA to defer further while the AP sends the IEEE 802.11ax data.

Any one or more of the above aspects, wherein, based on the NB trigger, the AS sends the NB data to a LP-NB STA while the AP is sending the IEEE 802.11ax data.

Any one or more of the above aspects, wherein the NB data has a first RU allocation, and wherein the IEEE 802.11ax data has a second RU allocation.

Any one or more of the above aspects, wherein the processor is further to send a wake-up packet to the LP-NB STA, and wherein, in response to receiving the wake-up packet, the LP-NB STA sends a wake-up ack to the AS.

Any one or more of the above aspects, wherein the AS interprets the ack as an indication that the LP-NB STA is ready to receive the NB data.

Any one or more of the above aspects, wherein the processor is further to: send a second NB trigger frame, wherein the second NB trigger frame causes the LP-NB STA to send second NB data to the AS; and receive the second NB data from the AS.

Any one or more of the above aspects, wherein the NB data sent to the assisting station (AS) is sent in an IEEE 802.11ax packet.

Any one or more of the above aspects, wherein the processor is further to: send a third NB trigger frame; and send third NB data directly to the LP-NB STA.

A method comprising: an access point (AP) sending a narrowband (NB) trigger frame to a low-power NB station (LP-NB STA); along with the trigger frame, the AP sending NB data to an assisting station (AS); in response to sending the NB data, the AP receiving a first acknowledgement (ack) from the AS; the AP sending an IEEE 802.11ax trigger frame to an IEEE 802.11ax station (STA); the AP sending IEEE 802.11ax data to the IEEE 802.11ax STA; and in response to sending the IEEE 802.11ax data, the AP receiving a second ack from the IEEE 802.11ax STA.

Any one or more of the above aspects, further comprising the AP sending a legacy preamble before the NB trigger frame, wherein the legacy preamble causes a legacy STA to defer while the NB data is sent.

Any one or more of the above aspects, wherein, in response to the legacy preamble, the IEEE 802.11ax STA defers while the AP sends the NB trigger frame.

Any one or more of the above aspects, wherein the IEEE 802.11ax trigger frame causes the legacy STA to defer further while the AP sends the IEEE 802.11ax data.

Any one or more of the above aspects, wherein, based on the NB trigger, the AS sends the NB data to a LP-NB STA while the AP is sending the IEEE 802.11ax data.

Any one or more of the above aspects, wherein the NB data has a first RU allocation, and wherein the IEEE 802.11ax data has a second RU allocation.

Any one or more of the above aspects, further comprising the AP sending a wake-up packet to the LP-NB STA, and wherein, in response to receiving the wake-up packet, the LP-NB STA sends a wake-up ack to the AS.

Any one or more of the above aspects, wherein the AS interprets the ack as an indication that the LP-NB STA is ready to receive the NB data.

Any one or more of the above aspects, further comprising the AP: sending a second NB trigger frame, wherein the second NB trigger frame causes the LP-NB STA to send second NB data to the AS; and receiving the second NB data from the AS.

Any one or more of the above aspects, wherein the NB data sent to the assisting station (AS) is sent in an IEEE 802.11ax packet.

Any one or more of the above aspects, further comprising the AP: sending a third NB trigger frame; and sending third NB data directly to the LP-NB STA.

A wireless access point comprising: means for sending a narrowband (NB) trigger frame to a low-power NB station (LP-NB STA); along with the trigger frame, means for sending NB data to an assisting station (AS); in response to sending the NB data, means for receiving a first acknowledgement (ack) from the AS; means for sending an IEEE 802.11ax trigger frame to an IEEE 802.11ax station (STA); means for sending IEEE 802.11ax data to the IEEE 802.11ax STA; and in response to sending the IEEE 802.11ax data, means for receiving a second ack from the IEEE 802.11ax STA.

Any one or more of the above aspects, further comprising means for sending a legacy preamble before the NB trigger frame, wherein the legacy preamble causes a legacy STA to defer while the NB data is sent.

Any one or more of the above aspects, wherein, in response to the legacy preamble, the IEEE 802.11ax STA defers while means for sends the NB trigger frame.

Any one or more of the above aspects, wherein the IEEE 802.11ax trigger frame causes the legacy STA to defer further while means for sends the IEEE 802.11ax data.

Any one or more of the above aspects, wherein, based on the NB trigger, the AS sends the NB data to a LP-NB STA while means for is sending the IEEE 802.11ax data.

Any one or more of the above aspects, wherein the NB data has a first RU allocation, and wherein the IEEE 802.11ax data has a second RU allocation.

Any one or more of the above aspects, further comprising means for sending a wake-up packet to the LP-NB STA, and wherein, in response to receiving the wake-up packet, the LP-NB STA sends a wake-up ack to the AS.

Any one or more of the above aspects, wherein the AS interprets the ack as an indication that the LP-NB STA is ready to receive the NB data.

Any one or more of the above aspects, further comprising means for: sending a second NB trigger frame, wherein the second NB trigger frame causes the LP-NB STA to send second NB data to the AS; and receiving the second NB data from the AS.

Any one or more of the above aspects, wherein the NB data sent to the assisting station (AS) is sent in an IEEE 802.11ax packet.

Any one or more of the above aspects, further comprising means for: sending a third NB trigger frame; and sending third NB data directly to the LP-NB STA.

A non-transitory information storage media having stored thereon one or more instructions, that when executed by one or more processors, cause an assisting station (STA) to perform a method, the method comprising: sending a narrowband (NB) trigger frame to a low-power NB station (LP-NB STA); along with the trigger frame, sending NB data to an assisting station (AS); in response to sending the NB data, receiving a first acknowledgement (ack) from the AS; sending an IEEE 802.11ax trigger frame to an IEEE 802.11ax station (STA); sending IEEE 802.11ax data to the IEEE 802.11ax STA; and in response to sending the IEEE 802.11ax data, receiving a second ack from the IEEE 802.11ax STA.

Any one or more of the above aspects, the method further comprising sending a legacy preamble before the NB trigger frame, wherein the legacy preamble causes a legacy STA to defer while the NB data is sent.

Any one or more of the above aspects, wherein, in response to the legacy preamble, the IEEE 802.11ax STA defers while sends the NB trigger frame.

Any one or more of the above aspects, wherein the IEEE 802.11ax trigger frame causes the legacy STA to defer further while sends the IEEE 802.11ax data.

Any one or more of the above aspects, wherein, based on the NB trigger, the AS sends the NB data to a LP-NB STA while is sending the IEEE 802.11ax data.

Any one or more of the above aspects, wherein the NB data has a first RU allocation, and wherein the IEEE 802.11ax data has a second RU allocation.

Any one or more of the above aspects, the method further comprising sending a wake-up packet to the LP-NB STA, and wherein, in response to receiving the wake-up packet, the LP-NB STA sends a wake-up ack to the AS.

Any one or more of the above aspects, wherein the AS interprets the ack as an indication that the LP-NB STA is ready to receive the NB data.

Any one or more of the above aspects, the method further comprising: sending a second NB trigger frame, wherein the second NB trigger frame causes the LP-NB STA to send second NB data to the AS; and receiving the second NB data from the AS.

Any one or more of the above aspects, wherein the NB data sent to the assisting station (AS) is sent in an IEEE 802.11ax packet.

Any one or more of the above aspects, the method further comprising: sending a third NB trigger frame; and sending third NB data directly to the LP-NB STA.

A non-transitory information storage media having stored thereon one or more instructions, that when executed by one or more processors, cause an assisting station (STA) to perform a method, the instructions comprising: instructions to receive the narrowband (NB) data from an access point (AP) in a NB trigger frame or in a separate frame sent by the AP; instructions to buffer the NB data; in response to receiving the NB data, instructions to send a first acknowledgement (ack) to the AP; instructions to receive an IEEE 802.11ax trigger frame; based on the IEEE 802.11ax trigger frame, instructions to send the NB data to a low-power NB station (LP-NB STA)-, when the AP is sending IEEE 802.11ax data to an IEEE 802.11ax STA; and in response to sending the NB data to the LP-NB STA, instructions to receive a second ack from the LP-NB STA.

Any one or more of the above aspects, wherein the NB data has a first RU allocation, wherein the IEEE 802.11ax data has a second RU allocation.

Any one or more of the above aspects, the instructions further comprising: instructions to receive a wake-up ack from the LP-NB STA, wherein the LP-NB STA sends the wake-up ack in response to receiving a wake-up packet; and in response to receiving the wake-up ack, instructions to send the wake-up ack to the AP.

Any one or more of the above aspects, the instructions further comprising: instructions to interpret the wake-up ack as an indication that the LP-NB STA is ready to receive the NB data; and in response to the wake-up ack, instructions to send the NB data.

Any one or more of the above aspects, the instructions further comprising: instructions to receive a second NB trigger frame from the AP; in response to the second NB trigger frame, instructions to receive second NB data from the LP-NB STA; and instructions to send the second NB data to the AP.

A method comprising: an assisting station (AS) receiving the narrowband (NB) data from an access point (AP) in a NB trigger frame or in a separate frame sent by the AP; the AS buffering the NB data; in response to receiving the NB data, the AS sending a first acknowledgement (ack) to the AP; the AS receiving an IEEE 802.11ax trigger frame; based on the IEEE 802.11ax trigger frame, the AS sending the NB data to a low-power NB station (LP-NB STA), when the AP is sending IEEE 802.11ax data to an IEEE 802.11ax STA; and in response to sending the NB data to the LP-NB STA, the AS receiving a second ack from the LP-NB STA.

Any one or more of the above aspects, wherein the NB data has a first RU allocation, and wherein the IEEE 802.11ax data has a second RU allocation.

Any one or more of the above aspects, the method further comprising: the AS receiving a wake-up ack from the LP-NB STA, wherein the LP-NB STA sends the wake-up ack in response to receiving a wake-up packet; and in response to receiving the wake-up ack, the AS sending the wake-up ack to the AP.

Any one or more of the above aspects, the method further comprising: the AS interpreting the wake-up ack as an indication that the LP-NB STA is ready to receive the NB data; and in response to the wake-up ack, the AS sending the NB data.

Any one or more of the above aspects, the method further comprising: the AS receiving a second NB trigger frame from the AP; in response to the second NB trigger frame, the AS receiving second NB data from the LP-NB STA; and the AS sending the second NB data to the AP.

A wireless communications device comprising: means for receiving the narrowband (NB) data from an access point (AP) in a NB trigger frame or in a separate frame sent by the AP; means for buffering the NB data; in response to receiving the NB data, means for sending a first acknowledgement (ack) to the AP; means for receiving an IEEE 802.11ax trigger frame; based on the IEEE 802.11ax trigger frame, means for sending the NB data to a low-power NB station (LP-NB STA), when the AP is sending IEEE 802.11ax data to an IEEE 802.11ax STA; and in response to sending the NB data to the LP-NB STA, means for receiving a second ack from the LP-NB STA.

Any one or more of the above aspects, wherein the NB data has a first RU allocation, and wherein the IEEE 802.11ax data has a second RU allocation.

Any one or more of the above aspects, the wireless communications device further comprising: means for receiving a wake-up ack from the LP-NB STA, wherein the LP-NB STA sends the wake-up ack in response to receiving a wake-up packet; and in response to receiving the wake-up ack, means for sending the wake-up ack to the AP.

Any one or more of the above aspects, the wireless communications device further comprising: means for interpreting the wake-up ack as an indication that the LP-NB STA is ready to receive the NB data; and in response to the wake-up ack, means for sending the NB data.

Any one or more of the above aspects, the wireless communications device further comprising: means for receiving a second NB trigger frame from the AP; in response to the second NB trigger frame, means for receiving second NB data from the LP-NB STA; and means for sending the second NB data to the AP.

A wireless communications device comprising: a memory; a processor in communication with the memory, the processor to: receive the narrowband (NB) data from an access point (AP) in a NB trigger frame or in a separate frame sent by the AP; buffer the NB data; in response to receiving the NB data, send a first acknowledgement (ack) to the AP; receive an IEEE 802.11ax trigger frame; based on the IEEE 802.11ax trigger frame, send the NB data to a low-power NB station (LP-NB STA), when the AP is sending IEEE 802.11ax data to an IEEE 802.11ax STA; and in response to sending the NB data to the LP-NB STA, receive a second ack from the LP-NB STA.

Any one or more of the above aspects, wherein the NB data has a first RU allocation, and wherein the IEEE 802.11ax data has a second RU allocation.

Any one or more of the above aspects, the processor further to: receive a wake-up ack from the LP-NB STA, wherein the LP-NB STA sends the wake-up ack in response to receiving a wake-up packet; and in response to receiving the wake-up ack, send the wake-up ack to the AP.

Any one or more of the above aspects, the processor further to: interpret the wake-up ack as an indication that the LP-NB STA is ready to receive the NB data; and in response to the wake-up ack, send the NB data.

Any one or more of the above aspects, the processor further to: receive a second NB trigger frame from the AP; in response to the second NB trigger frame, receive second NB data from the LP-NB STA; and send the second NB data to the AP.

A method comprising: a low power narrowband station (LP-NB STA) receiving a first NB trigger frame from an access point (AP); in response to receiving the first NB trigger frame, the LP-NB STA receiving NB data from an assisting STA (AS), when the AP is sending IEEE 802.11ax data to an IEEE 802.11ax STA, wherein the sending IEEE 802.11ax data to an IEEE 802.11ax STA is triggered by a second IEEE 802.11ax trigger frame sent after the first NB trigger frame; and in response to receiving the NB data, the LP-NB STA sending an acknowledgment (ack) to the AS.

Any one or more of the above aspects, wherein the NB data has a first RU allocation, wherein the IEEE 802.11ax data has a second RU allocation, wherein the first RU allocation is defined by the NB trigger frame.

Any one or more of the above aspects, further comprising: receiving a wake-up packet; and the LP-NB STA sending a wake-up ack to the AS, in response to receiving a wake-up packet in the second NB trigger frame, wherein the AS interprets the wake-up ack as an indication that the LP-NB STA is ready to receive the NB data, wherein, in response to the wake-up ack, the AS sends the NB data.

Any one or more of the above aspects, wherein the second NB trigger frame is received before the first NB trigger frame.

Any one or more of the above aspects, further comprising: receiving a third NB trigger frame from the AP; in response to the third NB trigger frame, sending second NB data to the AS; and receiving a second ack from the AS in response to sending the second NB data to the AS.

Any one or more of the above aspects, wherein the AS is in physical proximity of the LP-NB STA.

A wireless communications device comprising: means for receiving a first NB trigger frame from an access point (AP); in response to receiving the first NB trigger frame, means for receiving NB data from an assisting STA (AS), when the AP is sending IEEE 802.11ax data to an IEEE 802.11ax STA, wherein the sending IEEE 802.11ax data to an IEEE 802.11ax STA is triggered by a second IEEE 802.11ax trigger frame sent after the first NB trigger frame; and in response to receiving the NB data, means for sending an acknowledgment (ack) to the AS.

Any one or more of the above aspects, wherein the NB data has a first RU allocation, wherein the IEEE 802.11ax data has a second RU allocation, wherein the first RU allocation is defined by the NB trigger frame.

Any one or more of the above aspects, further comprising: means for receiving a wake-up packet; and means for sending a wake-up ack to the AS, in response to receiving a wake-up packet in the second NB trigger frame, wherein the AS interprets the wake-up ack as an indication that the wireless communications device is ready to receive the NB data, wherein, in response to the wake-up ack, the AS sends the NB data.

Any one or more of the above aspects, wherein the second NB trigger frame is received before the first NB trigger frame.

Any one or more of the above aspects, further comprising: receiving a third NB trigger frame from the AP; in response to the third NB trigger frame, sending second NB data to the AS; and receiving a second ack from the AS in response to sending the second NB data to the AS.

Any one or more of the above aspects, wherein the AS is in physical proximity of the wireless communications device.

A non-transitory information storage media having stored thereon one or more instructions, that when executed by one or more processors, cause an low-power narrowband station (LP-NB STA) to perform a method, the method comprising: receiving a first NB trigger frame from an access point (AP); in response to receiving the first NB trigger frame, receiving NB data from an assisting STA (AS), when the AP is sending IEEE 802.11ax data to an IEEE 802.11ax STA, wherein the sending IEEE 802.11ax data to an IEEE 802.11ax STA is triggered by a second IEEE 802.11ax trigger frame sent after the first NB trigger frame; and in response to receiving the NB data, sending an acknowledgment (ack) to the AS.

Any one or more of the above aspects, wherein the NB data has a first RU allocation, wherein the IEEE 802.11ax data has a second RU allocation, wherein the first RU allocation is defined by the NB trigger frame.

Any one or more of the above aspects, the method further comprising: receiving a wake-up packet; and sending a wake-up ack to the AS, in response to receiving a wake-up packet in the second NB trigger frame, wherein the AS interprets the wake-up ack as an indication that the LP-NB STA is ready to receive the NB data, wherein, in response to the wake-up ack, the AS sends the NB data.

Any one or more of the above aspects, wherein the second NB trigger frame is received before the first NB trigger frame.

Any one or more of the above aspects, the method further comprising: receiving a third NB trigger frame from the AP; in response to the third NB trigger frame, sending second NB data to the AS; and receiving a second ack from the AS in response to sending the second NB data to the AS.

Any one or more of the above aspects, wherein the AS is in physical proximity of the LP-NB STA.

A low power narrowband station (LP-NB STA) comprising: a memory; a processor in communication with the memory, the processor to: receive a first NB trigger frame from an access point (AP); in response to receiving the first NB trigger frame, receive NB data from an assisting STA (AS), when the AP is sending IEEE 802.11ax data to an IEEE 802.11ax STA, wherein the sending IEEE 802.11ax data to an IEEE 802.11ax STA is triggered by a second IEEE 802.11ax trigger frame sent after the first NB trigger frame; and in response to receiving the NB data, send an acknowledgment (ack) to the AS.

Any one or more of the above aspects, wherein the NB data has a first RU allocation, wherein the IEEE 802.11ax data has a second RU allocation, wherein the first RU allocation is defined by the NB trigger frame.

Any one or more of the above aspects, the processor further to: receive a wake-up packet; and send a wake-up ack to the AS, in response to receiving a wake-up packet in the second NB trigger frame, wherein the AS interprets the wake-up ack as an indication that the LP-NB STA is ready to receive the NB data, wherein, in response to the wake-up ack, the AS sends the NB data.

Any one or more of the above aspects, wherein the second NB trigger frame is received before the first NB trigger frame.

Any one or more of the above aspects, the processor further to: receive a third NB trigger frame from the AP; in response to the third NB trigger frame, send second NB data to the AS; and receive a second ack from the AS in response to sending the second NB data to the AS.

Any one or more of the above aspects, wherein the AS is in physical proximity of the LP-NB STA.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhanced communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless access point comprising:
a memory;
a processor in communication with the memory, the processor to:
send a narrowband (NB) trigger frame to a low-power NB station (LP-NB STA);
along with the trigger frame, send NB data to an assisting station (AS);
in response to sending the NB data, receive a first acknowledgement (ack) from the AS;
send an IEEE 802.11ax trigger frame to an IEEE 802.11ax station (STA);
send IEEE 802.11ax data to the IEEE 802.11ax STA; and
in response to sending the IEEE 802.11ax data, receive a second ack from the IEEE 802.11ax STA.

2. The wireless access point of claim 1, wherein the processor is further to send a legacy preamble before the NB trigger frame, wherein the legacy preamble causes a legacy STA to defer while the NB data is sent.

3. The wireless access point of claim 2, wherein, in response to the legacy preamble, the IEEE 802.11ax STA defers while the AP sends the NB trigger frame.

4. The wireless access point of claim 3, wherein the IEEE 802.11ax trigger frame causes the legacy STA to defer further while the AP sends the IEEE 802.11ax data.

5. The wireless access point of claim 1, wherein, based on the NB trigger, the AS sends the NB data to a LP-NB STA while the AP is sending the IEEE 802.11ax data.

6. The wireless access point of claim 1, wherein the NB data has a first RU allocation, and wherein the IEEE 802.11ax data has a second RU allocation.

7. The wireless access point of claim 1, wherein the processor is further to send a wake-up packet to the LP-NB STA, and wherein, in response to receiving the wake-up packet, the LP-NB STA sends a wake-up ack to the AS.

8. The wireless access point of claim 7, wherein the AS interprets the ack as an indication that the LP-NB STA is ready to receive the NB data.

9. The wireless access point of claim 1, wherein the processor is further to:
send a second NB trigger frame, wherein the second NB trigger frame causes the LP-NB STA to send second NB data to the AS; and
receive the second NB data from the AS.

10. The wireless access point of claim 1, wherein the NB data sent to the assisting station (AS) is sent in an IEEE 802.11ax packet.

11. The wireless access point of claim 1, wherein the processor is further to:
send a third NB trigger frame; and
send third NB data directly to the LP-NB STA.

12. A non-transitory information storage media having stored thereon one or more instructions, that when executed by one or more processors, cause an assisting station (STA) to perform a method, the instructions comprising:
instructions to receive the narrowband (NB) data from an access point (AP) in a NB trigger frame or in a separate frame sent by the AP;
instructions to buffer the NB data;
in response to receiving the NB data, instructions to send a first acknowledgement (ack) to the AP;
instructions to receive an IEEE 802.11ax trigger frame;
based on the IEEE 802.11ax trigger frame, instructions to send the NB data to a low-power NB station (LP-NB STA), when the AP is sending IEEE 802.11ax data to an IEEE 802.11ax STA; and
in response to sending the NB data to the LP-NB STA, instructions to receive a second ack from the LP-NB STA.

13. The media of claim 12, wherein the NB data has a first RU allocation, and wherein the IEEE 802.11ax data has a second RU allocation.

14. The media of claim 12, the instructions further comprising:
instructions to receive a wake-up ack from the LP-NB STA, wherein the LP-NB STA sends the wake-up ack in response to receiving a wake-up packet; and
in response to receiving the wake-up ack, instructions to send the wake-up ack to the AP.

15. The media of claim 14, the instructions further comprising:
instructions to interpret the wake-up ack as an indication that the LP-NB STA is ready to receive the NB data; and
in response to the wake-up ack, instructions to send the NB data.

16. The media of claim 12, the instructions further comprising:
instructions to receive a second NB trigger frame from the AP;
in response to the second NB trigger frame, instructions to receive second NB data from the LP-NB STA; and
instructions to send the second NB data to the AP.

17. A method comprising:
a low power narrowband station (LP-NB STA) receiving a first NB trigger frame from an access point (AP);
in response to receiving the first NB trigger frame, the LP-NB STA receiving NB data from an assisting STA (AS), when the AP is sending IEEE 802.11ax data to an IEEE 802.11ax STA, wherein the sending IEEE 802.11ax data to an IEEE 802.11ax STA is triggered by a second IEEE 802.11ax trigger frame sent after the first NB trigger frame; and
in response to receiving the NB data, the LP-NB STA sending an acknowledgment (ack) to the AS.

18. The method of claim 17, wherein the NB data has a first RU allocation, wherein the IEEE 802.11ax data has a second RU allocation, and wherein the first RU allocation is defined by the NB trigger frame.

19. The method of claim 17, further comprising:
receiving a wake-up packet; and
the LP-NB STA sending a wake-up ack to the AS, in response to receiving a wake-up packet in the second NB trigger frame, wherein the AS interprets the wake-up ack as an indication that the LP-NB STA is ready to receive the NB data, wherein, in response to the wake-up ack, the AS sends the NB data.

20. The method of claim 17, wherein the second NB trigger frame is received before the first NB trigger frame.

21. The method of claim 18, further comprising:
receiving a third NB trigger frame from the AP;
in response to the third NB trigger frame, sending second NB data to the AS; and
receiving a second ack from the AS in response to sending the second NB data to the AS.

22. The method of claim 17, wherein the AS is in physical proximity of the LP-NB STA.
